(19) United States
(12) Patent Application Publication
(10) Pub. No.: US 2019/0166425 A1
(43) Pub. Date: May 30, 2019

(54) NOVEL METHOD FOR IMPROVING THE DIFFUSION OF MUSICAL LOW FREQUENCIES ACCORDING TO THE AUDIO LEVEL

(71) Applicant: Claude CARPENTIER, Maisons Laffitte (FR)

(72) Inventor: Claude CARPENTIER, Maisons Laffitte (FR)

(21) Appl. No.: 16/321,050

(22) PCT Filed: Jul. 27, 2017
(86) PCT No.: PCT/FR2017/000147

§ 371 Date: Jan. 28, 2019

(30) Foreign Application Priority Data
Jul. 29, 2016 (FR) 1601171

(51) Int. Cl. H04R 3/04; G10L 21/0232

(52) U.S. Cl. CPC H04R 3/04; H04R 2400/01; H04R 2430/01; G10L 21/0232

(57) ABSTRACT

According to this method, the playback level of the music is measured as compared to a reference level and if the playback level is lower than the reference level the level of the low frequencies is increased in a manner substantially proportional to the difference between the reference level and the measured level to maintain the tonal balance of the musical piece.

In discotheques, the maximum listening level allowed by the law is 105 dB. He is naturally always reached and often exceeded. Also, the creators of modern music mix their works to be listened to at this level.

But, apart from the discotheques, there is only by car where one can reach this level of listening without getting angry with the whole neighborhood.

In apartment, it is advisable not to exceed 85 dB to not disturb the neighbors. Sometimes even we do not exceed 65 dB to not disturb the entourage or because we are busy with something else.

However, it is known that the relative sensitivity of the human ear to different audible frequencies varies with the level of listening and that in particular, the ear is less and less sensitive to low frequencies as the level of hearing listening turn down.

And so when listening at a level significantly lower than the level of listening to the mix, the reproduction seems to lack bass.

To compensate for this lack of bass, some HIFI amplifiers are equipped with a way to increase them. This means is often a push button that increases them by a fixed value, which in general does not correspond to the value required by the listening level.

A more advanced system is to provide an increase of the level of low frequencies coupled with the volume knob.

The company HARMAN in its U.S. Pat. No. 7,016,509 has proposed a low-frequencies measurement method based on the measurement of the level of the modulation signal which consists in effecting an increase in the level of the low frequencies inversely proportional to the level of the modulation.

These last two methods are purely electronic and they do not take into account the acoustic level of the modulation. They need to be calibrated to work properly which requires the intervention of a technician at the beginning of the installation which reserves them to very high-end installations

Also known is the patent US 2014/0321670 filed by SONY which describes a method of adjusting the relative level of low frequencies as a function of the sound level possibly measured using a microphone. But this process works badly because on the one hand the sound level is evaluated without weighting and on the other hand, it is not provided with a way to cancel the increase off bass in the absence of a signal, which means that when a piece of music begins with a powerful bass note which is not uncommon and the level of listening is important, the system saturates.

The present invention is a new automatic and precise method for adjusting the relative level of the low frequencies as a function of the sound level comprising on the one hand a weighted sound level evaluation means and on the other hand a means of suppressing the increase. low frequencies in the absence of a modulation signal.

For know the gain to be applied to a frequency band when the music is listened to below the reference level to maintain the relative level of audibility of the low frequencies, we consult the isosonic curves that are present in all manuals of acoustic.

Suppose the reproduction level is 70 dB and the reference level is 105 dB and we look for what gain to apply to the 40 Hz band.

At 105 dB it is necessary to increase the band of the 40 Hz of 12 dB to have the impression to hear it at the same level as the 1000 Hz band.

At 70 dB it is necessary to increase the band of the 40 Hz of 19 dB to have the impression to hear it at the same level as the band of the 1000 Hz.

It is therefore necessary to apply an increase in the 40 Hz band of 19 dB−12 dB=7 dB to maintain the apparent relative level of this frequency band.

The table below shows the gain to be applied to the 20 Hz, 40 Hz, 80 Hz and 160 Hz bands at the 100 dB, 80 dB, 70 dB and 60 dB listening levels to maintain the apparent relative level of low frequencies.

| | 20 Hz | 40 Hz | 80 Hz | 160 Hz |
|---|---|---|---|---|
| 100 dB | 1 | 0 | 0 | 0 |
| 90 dB | 3 | 1 | 0 | 0 |
| 80 dB | 7 | 3 | 1 | 0 |
| 70 dB | 12 | 7 | 3 | 1 |
| 60 dB | 16 | 10 | 6 | 2 |

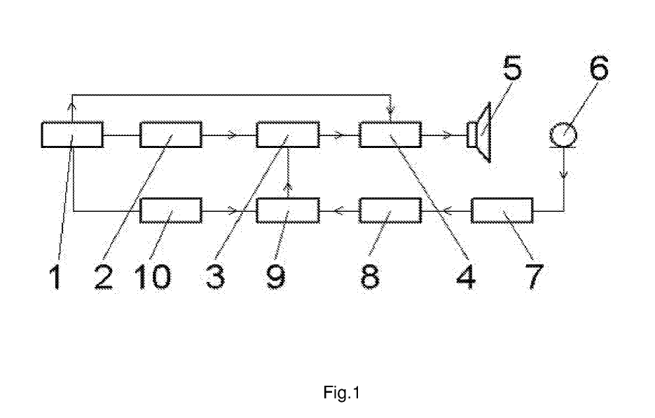

FIG. 1 is a general diagram of a device according to the method of the present invention. A sound modulation source 1 supplies a 1:2 low-pass filter. This filter supplies a voltage-controlled amplifier 3 which itself feeds a power amplifier 4 which sums the signal coming from 3 and the signal from 1 and supplies the speaker 5. The speaker thus emits a modulation which is the sum between the original modulation and the same original modulation filtered by a first-order low-pass filter whose level varies according to the sound pressure level emitted by the loudspeaker.

For this a microphone 6 delivers a voltage proportional to the sound pressure in the environment of the listener. This signal is filtered by a weighting filter 7.

Very good results are obtained by filtering the signal from the microphone using a filter reproducing the weighting curve A defined by the IEC 61672 standard.

The voltage from 7 is rectified by the rectifier without threshold 8. The DC voltage from 8 supplies the voltage configurator 9 responsible for developing a voltage able to drive the amplifier 3.

The modulation from 1 is introduced into the circuit 10 arranged to command at the circuit 9 the cancellation of increase the level of bass frequencies in the absence of signal at the output of the source 1.

The transfer function of a low-pass filter composed of a resistor R and a capacitor C equal to:

$$\frac{1}{1 + jwRC}$$

G being the gain of the amplifier 3, the assembly of FIG. 1 provides a sound pressure proportional to:

$$[ 1 + \frac{G}{1 + jwRC} ]$$

Whose module is equal to:

$$\sqrt{\frac{{( G + 1 )}^{2} + {( RCw )}^{2}}{1 + {( RCw )}^{2}}}$$

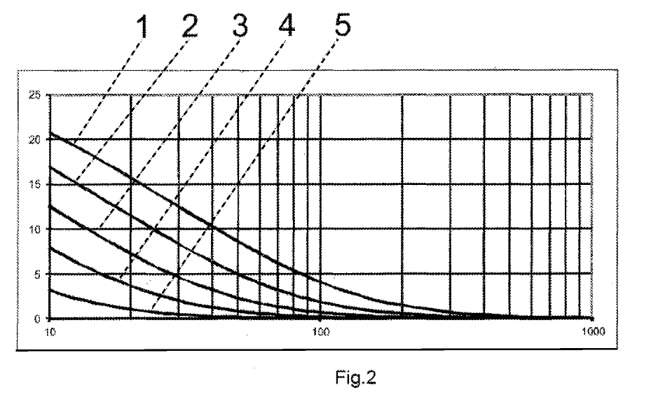

The curves of FIG. 2 are the decibel value of this module between 60 dB and 100 dB at different frequencies by taking RC=0.026.

Curve 1 is the response curve of the device of FIG. 1 for an acoustic level of 60 dB. It is obtained with G=20 that is to say 26 dB.

Curve 2 is the response curve of the device of FIG. 1 for an acoustic level of 70 dB. It is obtained with G=10 that is to say 20 dB.

Curve 3 is the response curve of the device of FIG. 1 for an acoustic level of 80 dB. It is obtained with G=5 that is to say 14 dB.

Curve 4 is the response curve of the device of FIG. 1 for an acoustic level of 90 dB. It is obtained with G=2.5 that is to say 8 dB.

Curve 5 is the response curve of the device of FIG. 1 for an acoustic level of 100 dB. It is obtained with G=1.25 that is to say 2 dB.

The amplifier 3 is a circuit THAT 2181 whose gain is equal to 1 when its control voltage is zero and which increases by 1 dB when its control voltage decreases by 0.006 volts.

At 60 dB the control voltage should be −0.156 volts

At 70 dB the control voltage should be −0.120 volts

At 80 dB the control voltage must be −0.084 volts

At 90 dB the control voltage must be −0.048 volts

At 100 dB the control voltage must be −0.012 volts

The voltage from the circuit 8 is equal to:
10 volts to 100 dB
3.3 volts at 90 dB
1 volt at 80 dB
0.33 volts to 70 dB
0.1 volts to 60 dB

It can be deduced that the output voltage of the circuit 9 must be equal to:

$$log \frac{{V}_{8}}{15} - 0 , 084 volts$$

This device could equip sound reproduction equipment.

1. A method of compensating the low frequencies level of a musical reproduction system increasing the relative level of low frequencies when the reproduction level decreases controlled by a microphone measuring the sound pressure in the listener's environment and characterized in that the sound pressure is measured through a weighting filter decreasing the influence of the low frequencies and by the fact that the increase of the low frequencies is canceled in the absence of sound modulation.

2. Low frequencies processing device implementing the method according to claim 1 comprising a calibrated microphone, a weighting filter A, a rectifier circuit, a voltage configurator adapted to control a voltage controlled amplifier allowing to increase the level of low frequencies according to the sound level detected by the microphone and means for detecting the level of the source signal commanding the cancellation of the increase of the relative level of the low frequencies in the absence of sound modulation.

3. Sound reproduction equipment equipped with a low frequencies processing device according to the method of claim 2.
